(19) United States
(12) Patent Application Publication
(10) Pub. No.: US 2023/0278022 A1
(43) Pub. Date: Sep. 7, 2023

(54) HONEYCOMB STRUCTURE, ELECTRICALLY HEATING CATALYST SUPPORT AND EXHAUST GAS PURIFYING DEVICE

(71) Applicants: NGK Insulators, Ltd., Nagoya-City (JP); Toyota Jidosha Kabushiki Kaisha, Toyota-Shi (JP)

(72) Inventors: Taro OSADA, Nagoya-City (JP); Yukiharu MORITA, Nagoya-City (JP); Takayuki INOUE, Nagoya-City (JP); Yuko KOZAKI, Inazawa-City (JP); Yuto NAITO, Kasugai-City (JP); Takahiro SADAMITSU, Miyoshi-City (JP)

(73) Assignees: NGK Insulators, Ltd., Nagoya-City (JP); Toyota Jidosha Kabushiki Kaisha, Toyota-Shi (JP)

(21) Appl. No.: 18/171,745

(22) Filed: Feb. 21, 2023

(30) Foreign Application Priority Data
Mar. 2, 2022 (JP) 2022-032110

(51) Int. Cl. B01J 35/04; B01J 35/00; B01J 35/10; B01J 27/224; B01D 53/94; F01N 3/20; F01N 3/28

(52) U.S. Cl. CPC B01J 35/04; B01D 53/94; B01J 27/224; B01J 35/0033; B01J 35/109; F01N 3/2026; F01N 3/2828; F01N 3/2842; B01D 2255/9155; F01N 2330/30; F01N 2370/04

(57) ABSTRACT

A honeycomb structure 20 according to the present invention includes: a ceramic honeycomb structure portion 10 including: an outer peripheral wall 12; a partition wall 13, the partition wall 13 defining a plurality of cells 16; and a pair of electrode layers 14a, 14b each arranged so as to extend in a form of a band on an outer surface of the outer peripheral wall 12, across a central axis of the honeycomb structure portion 10, wherein the honeycomb structure portion 10 is provided in an end portion region(s) extending in a direction from the one end face and/or the other end face to a center in a flow path length direction of the honeycomb structure portion 10, and the honeycomb structure portion 10 comprises at least one low porosity portion 4 having a lower porosity than an average porosity of the whole honeycomb structure portion 10.

### FIELD OF THE INVENTION

The present invention relates to a honeycomb structure, an electrically heating catalyst support and an exhaust gas purifying device.

### BACKGROUND OF THE INVENTION

Patent Literature 1 as described below proposes the use of a honeycomb structure as an electrically heating catalyst support. The honeycomb structure includes: a cylindrical honeycomb structure portion having a porous partition wall defining a plurality of cells and an outer peripheral wall; and a pair of electrode portions arranged on a side surface of the honeycomb structure portion, wherein the honeycomb structure is configured to function as a catalyst support and also as a heater by applying a voltage.

### CITATION LIST

### Patent Literature

[Patent Literature 1] WO 2011/125815 A1

### SUMMARY OF THE INVENTION

In recent years, the maximum temperature of exhaust gases from internal combustion engines has increased due to the influence of fuel efficiency regulations on automobiles, and further improvement has been required in terms of thermal shock resistance. In particular, when cracks are generated in end faces of a honeycomb structure, heat generation performance required during electric heating may not be satisfied because electricity will not flow to the cracked portions. Therefore, it is necessary to suppress cracks that are generated on the end faces of the honeycomb structure due to the thermal shock caused by the exhaust gas.

The present invention was made to solve the problems as described above. An object of the present invention is to provide a honeycomb structure, an electrically heating catalyst support, and an exhaust gas purifying device, which can suppress cracks generated on the end faces of the honeycomb structure.

A honeycomb structure according to the present invention comprises: a ceramic honeycomb structure portion including: an outer peripheral wall; a partition wall arranged on an inner side of the outer peripheral wall, the partition wall defining a plurality of cells each extending from one end face to other end face to form a flow path; and a pair of electrode layers each arranged so as to extend in a form of a band on an outer surface of the outer peripheral wall, across a central axis of the honeycomb structure portion, wherein the honeycomb structure portion is provided in an end portion region(s) extending in a direction from the one end face and/or the other end face to a center in a flow path length direction of the honeycomb structure portion, and the honeycomb structure portion comprises at least one low porosity portion having a lower porosity than an average porosity of the whole honeycomb structure portion.

An electrically heating catalyst support according to the present invention comprises: the honeycomb structure as described above; and a catalyst supported onto the honeycomb structure.

An exhaust gas purifying device according to the present invention comprises: the honeycomb structure as described above; electrode terminals provided on a pair of electrode layers; and a metallic can body for holding the honeycomb structure.

According to the honeycomb structure, the electrically heating catalyst support, and the exhaust gas purifying device according to the present invention, the honeycomb structure portion is provided in an end portion region(s) extending in a direction from at least one end face to a center in a flow path length direction of the honeycomb structure portion, and the honeycomb structure portion comprises a low porosity portion having a lower porosity than an average porosity of the whole honeycomb structure portion, so that cracks generated on the end faces of the honeycomb structure can be suppressed.

### BRIEF DESCRIPTION OF THE DRAWINGS

FIG. 1 is a schematic external view of a honeycomb structure according to an embodiment of the present invention; and

FIG. 2 is a schematic cross-sectional view of a honeycomb structure and electrode terminals provided on electrode layers of the honeycomb structure, which is perpendicular to an extending direction of cells.

### DETAILED DESCRIPTION OF THE INVENTION

Hereinafter, embodiments of a honeycomb structure, an electrically heating catalyst support, and an exhaust gas purifying device according to the present invention will be described with reference to the drawings. However, the present invention should not be interpreted as being limited to those embodiments, and various changes, modifications and improvements may be made based on the knowledge of one of ordinary skill in the art without departing from the scope of the invention.

### Honeycomb Structure

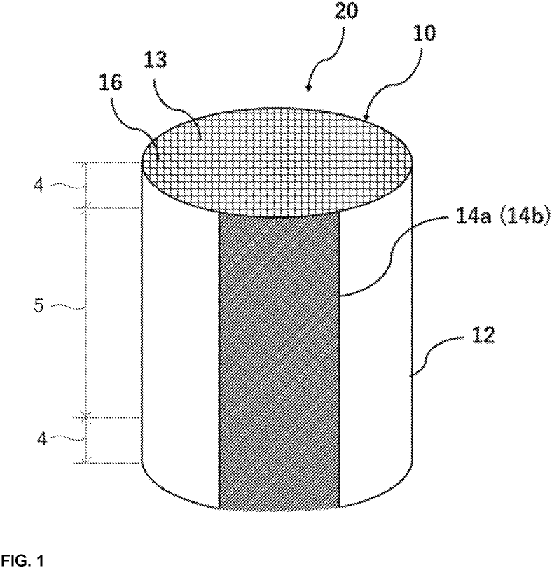

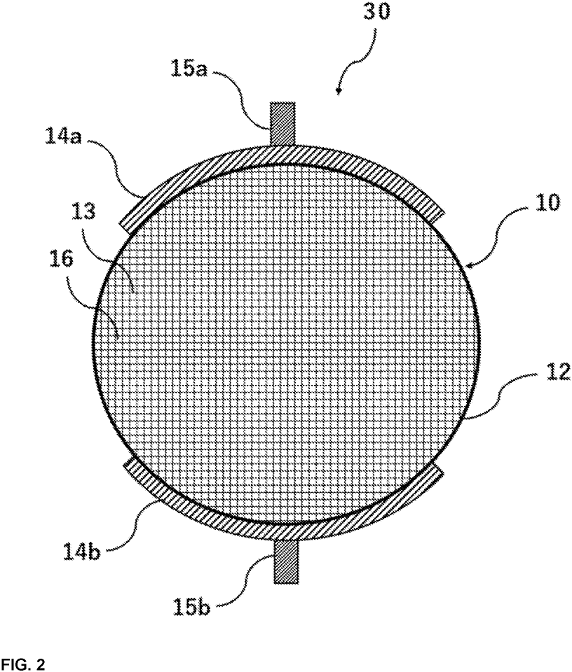

FIG. 1 is a schematic external view of a honeycomb structure 20 according to an embodiment of the present invention. FIG. 2 is a schematic cross-sectional view of the honeycomb structure 20 according to an embodiment of the present invention and electrode terminals 15a, 15b provided on electrode layers 14a, 14b of the honeycomb structure 20, which is perpendicular to an extending direction of cells 16.

The honeycomb structure 20 includes the honeycomb structure portion 10 and a pair of electrode layers 14a, 14b.

### (1. Honeycomb Structure Portion)

The honeycomb structure portion 10 is a pillar shaped member made of ceramics, and has an outer peripheral wall 12 and a partition wall 13 that is arranged on an inner side of the outer peripheral wall 12 and defines a plurality of cells 16 each extending from one end face to the other end face to form a flow path. It is understood that the pillar shape is a three-dimensional shape having a thickness in an extending direction of the cells 16 (a flow path length direction of the honeycomb structure portion 10). A ratio of a length of the honeycomb structure portion 10 in the flow path length direction to a diameter or width of the end face of the honeycomb structure portion 10 (aspect ratio) is arbitrary. The pillar shape may also include a shape in which the length of the honeycomb structure portion 10 in the flow path length direction is shorter than the diameter or width of the end face (flat shape).

An outer shape of the honeycomb structure portion 10 is not particularly limited as long as it has a pillar shape. For example, it can be other shapes such as a pillar shape having circular end faces (cylindrical shape), a pillar shape having oval end faces, and a pillar shape having polygonal (rectangular, pentagonal, hexagonal, heptagonal, octagonal, etc.) end faces. As for the size of the honeycomb structure portion 10, an area of the end faces is preferably from 2,000 to 20,000 mm², and even more preferably from 5,000 to 15,000 mm², in order to increase heat resistance (to suppress cracks generated in the circumferential direction of the outer peripheral wall).

A shape of each cell 16 in the cross section perpendicular to the extending direction of the cells 16 may preferably be a quadrangle, hexagon, octagon, or a combination thereof, although not limited thereto. Among these, the quadrangle and the hexagon are preferred, because they can lead to a decreased pressure loss upon flowing of an exhaust gas through the honeycomb structure portion 10 when a catalyst is supported onto the honeycomb structure portion 10 to form an electrically heating catalyst support 30, thereby providing improved purification performance. The hexagon is even more preferable from the viewpoint that the purification performance of the catalyst can be more improved.

The partition wall 13 that defines the cells 16 preferably has a thickness of from 0.1 to 0.3 mm, and more preferably from 0.1 to 0.2 mm. The thickness of 0.1 mm or more of the partition wall 13 can suppress a decrease in the strength of the honeycomb structure portion 10. The thickness of the partition wall 13 of 0.3 mm or less can suppress a larger pressure loss when an exhaust gas flows through the honeycomb structure portion 10 if a catalyst is supported onto the honeycomb structure portion 10 to form the electrically heating catalyst support 30. In the present invention, the thickness of the partition wall 13 is defined as a length of a portion passing through the partition wall 13, among line segments connecting the centers of gravity of adjacent cells 16, in the cross section perpendicular to the extending direction of the cells 16.

The honeycomb structure portion 10 preferably has a cell density of from 40 to 150 cells/cm², and more preferably from 70 to 100 cells/cm², in the cross section perpendicular to the extending direction of the cells 16. The cell density in such a range can allow the purification performance of the catalyst to be increased while reducing the pressure loss upon the flowing of the exhaust gas, when a catalyst is supported onto the honeycomb structure portion 10 to form the electrically heating catalyst support 30. The cell density of 40 cells/cm² or more can allow a catalyst support area to be sufficiently ensured. The cell density of 150 cells/cm² or less can prevent the pressure loss when the exhaust gas flows through the honeycomb structure portion 10 from being increased. The cell density is a value obtained by dividing the number of cells by the area of one end face portion of the honeycomb structure portion 10 excluding the outer peripheral wall 12 portion.

The provision of the outer peripheral wall 12 of the honeycomb structure portion 10 is useful from the viewpoints of ensuring the structural strength of the honeycomb structure portion 10 and suppressing the leakage of the fluid flowing through the cells 16 from the outer peripheral wall 12. Specifically, the thickness of the outer peripheral wall 12 is preferably 0.05 mm or more, and more preferably 0.10 mm or more, and even more preferably 0.15 mm or more. However, if the outer peripheral wall 12 is too thick, the strength will be too high, and a strength balance between the outer peripheral wall 12 and the partition wall 13 will be lost, resulting in a decrease in thermal shock resistance. Therefore, the thickness of the outer peripheral wall 12 is preferably 1.0 mm or less, and more preferably 0.7 mm or less, and even more preferably 0.5 mm or less. The thickness of the outer peripheral wall 12 is defined as a thickness of the outer peripheral wall 12 in the normal line direction relative to the tangent line at a measured point when the point of the outer peripheral wall 12 where the thickness is to be measured is observed in the cross section perpendicular to the extending direction of the cells 16.

The honeycomb structure portion 10 has electrical conductivity. Volume resistivity is not particularly limited as long as the honeycomb structure portion 10 is capable of heat generation by Joule heat when a current is applied. Preferably, the volume resistivity is from 0.1 to 200 Ω·cm, and more preferably from 1 to 200 Ω·cm. As used herein, the volume resistivity of the honeycomb structure portion 10 refers to a value measured at 25° C. by the four-terminal method.

The honeycomb structure portion 10 can be made of a material selected from non-oxide ceramics such as silicon carbide, silicon nitride and aluminum nitride, although not limited thereto. Further, silicon carbide-metal-silicon composites and silicon carbide/graphite composites can also be used. Among these, it is preferable that the material of the honeycomb structure portion 10 contains ceramics mainly based on a silicon-silicon carbide composite material or silicon carbide, in terms of balancing heat resistance and electrical conductivity. The phrase “the material of the honeycomb structure portion 10 is mainly based on silicon-silicon carbide composite material” means that the honeycomb structure portion 10 contains 90% by mass of more of silicon-silicon carbide composite material (total mass) based on the total material. Here, the silicon-silicon carbide composite material contains silicon carbide particles as an aggregate and silicon as a binding material to bind the silicon carbide particles, preferably in which a plurality of silicon carbide particles are bound by silicon such that pores are formed between the silicon carbide particles. The phrase “the material of the honeycomb structure portion 10 is mainly based on silicon carbide” means that the honeycomb structure portion 10 contains 90% or more of silicon carbide (total mass) based on the total material.

As shown in FIG. 1, the honeycomb structure portion 10 has a low porosity portion 4. The low porosity portion 4 is provided in an end region(s) extending a direction from the one end face and/or the other end face to a center in the flow path length direction of the honeycomb structure portion 10, and is a portion having a lower porosity than an average porosity of the whole honeycomb structure portion 10. The average porosity of the whole honeycomb structure 10 is an arithmetic average value of the porosities measured at five positions of the honeycomb structure portion 10. The positions where the porosity is measured to obtain the average porosity are five position in total: end face positions (two positions) on both sides of the honeycomb structure portion 10; positions (two positions) each from the end face positions on both sides to the center in the flow path length direction by ¼ of the total length of the honeycomb structure portion 10 in the flow path length direction; and a central position (one position) in the flow path length direction of the honeycomb structure portion 10. The porosity is determined by cutting the honeycomb structure portion 10 in the radial direction so as to obtain porosity measuring samples (cut bodies) at respective positions, and measuring the porosities at the geometric center positions of the end faces of the porosity measuring samples (cut bodies).

In this specification, the porosity can be determined as follows. That is, each measurement position of the honeycomb structure portion 10 is observed with a scanning electron microscope (SEM), and its SEM image is acquired. It should be noted that the SEM image is observed by magnifying it by 200 times. Subsequently, by image analysis of the acquired SEM image, solid portions and void portions (pores) of the partition wall 13 are binarized in a portion of the partition wall 13 (the portion other than the cells 16) of the honeycomb structure 10. Then, a percentage of the void portions in the partition wall 13 to the total area of the solid portions and the void portions of the partition wall 13 is calculated, and the resulting value is defined as the porosity of the honeycomb structure portion 10. It should be noted that when measuring the porosity of the electrically heating catalyst support 30 having a catalyst supported onto the honeycomb structure portion 10, the catalyst portion is regarded as the void portions of the partition wall 13.

A method for identifying the low porosity portion 4 is as follows. When the average porosity of the whole honeycomb structure portion 10 is 100%, a portion where the porosity is 99% or less from one end face and the other end face is defined as the low porosity portion 4. Then, the central portion in the flow path length direction of the honeycomb structure portion 10, which has a porosity more than 99%, is defined as a portion 5 other than the low porosity portion 4. The low porosity portion 4 may extend only from one end face or the other end face of the honeycomb structure portion 10 in a direction toward the center of the flow path length direction of the honeycomb structure portion 10. In this case, the other end face or the one end face without the low porosity portion 4 becomes the portion 5 other than the low porosity portion 4 up to the end face.

Since the low porosity portion 4 has a low porosity, it has a larger heat capacity than other portions of the honeycomb structure portion 10. Therefore, even if a temperature of a fluid such as an exhaust gas flowing into the flow path of the honeycomb structure 10 is changed, a temperature change in the end portion regions becomes gentle, resulting in difficulty to increase a temperature difference between the end portion region and the central region of the honeycomb structure 10 in the flow path length direction. This can suppress cracks generated at the end faces of the honeycomb structure portion 10 or the honeycomb structure 20.

In addition, when the porosity of the whole honeycomb structure portion 10 is lower, the heat capacity of the whole honeycomb structure portion 10 becomes larger. In this case, although the temperature change in the whole honeycomb structure 10 is gentle, when the temperature of the fluid is changed, the temperature difference between the central region and the end regions in the flow path length direction of the honeycomb structure 10 is increased, so that it is difficult to suppress the cracks generated on the end faces. Moreover, if the heat capacity of the whole honeycomb structure 10 is larger, the temperature of the honeycomb structure 10 may be difficult to increase during electrical heating. From these points of view, it is preferable to provide the low porosity portions 4 in the end regions.

As shown in FIG. 1, the low porosity portions 4 may be formed in the respective end portion regions (the end portion regions on both sides) extending in a direction from one end face and the other end face to the center of the flow path length direction of the honeycomb structure body 10, or the low porosity portion 4 may be provided only in the end portion region (one end portion region) extending from the one end face or the other end surface. Regardless of whether the low porosity portions 4 are provided on both sides or the low porosity portion is provided on one side, the low porosity portion(s) 4 is/are preferably provided in the end region(s) on the fluid inlet side (one end face where the end portion region provided with the low porosity portion 4 extends is preferably the end face on the fluid inlet side). In other words, it is preferable to use the honeycomb structure 10 in such a direction that the end portion region provided with the low porosity portion 4 is located on the fluid inlet side. The fluid may be an exhaust gas.

The extension width of the low porosity portion 4 in the flow path length direction of the honeycomb structure portion 10 is preferably 0.5% or more and 40% or less of the total length of the honeycomb structure portion 10 in the flow path length direction of the honeycomb structure portion 10. The extension width of the low porosity portion 4 of 0.5% or more of the total length of the honeycomb structure portion 10 provides a sufficient amount of improvement of the heat capacity in the end portion regions, so that the effect of suppressing the cracks generated at the end faces of the honeycomb structure portion 10 or the honeycomb structure 20 is more likely to be improved. The extension width of the low porosity portion 4 of 40% or less of the total length of the honeycomb structure portion 10 can allow the difference between the heat capacity of the end portion regions of the honeycomb structure portion 10 and the heat capacity of other portions to be sufficiently maintained, so that the effect of suppressing the cracks generated at the end faces can be improved. The extension width of the low porosity portion 4 is more preferably 0.5% or more and 15% or less of the total length of the honeycomb structure portion 10, and even more preferably 0.5% or more and 10% or less.

The extension width of the low porosity portion 4 in the flow path length direction of the honeycomb structure portion 10 is preferably 0.3 mm or more and 20 mm or less. The extension width of the low porosity portion 4 of 0.3 mm or more can provide a sufficient amount of improvement of the heat capacity in the end portion regions, so that the effect of suppressing the cracks generated at the end faces of the honeycomb structure portion 10 or the honeycomb structure 20 tends to be more improved. The extension width of the low porosity portion 4 of 20 mm or less can allow the difference between the heat capacity of the end portion regions of the honeycomb structure portion 10 and the heat capacity of other portions to be sufficiently maintained, so that the effect of suppressing the cracks generated at the end faces is improved. The extension width of the low porosity portion 4 is more preferably 0.3 mm or more and 10 mm or less, and even more preferably 0.3 mm or more and 6 mm or less.

It is preferable that a ratio of an average porosity (AP1) of the low porosity portion 4 to an average porosity (AP2) of the portion 5 other than the low porosity portion 4 ({(AP2 - AP1) / AP2)} × 100) is 0.2% or more and 99.9% or less. The ratio of 0.2% or more can provide a sufficient amount of improvement of the heat capacity of the end portion regions, so that the effect of suppressing the cracks generated at the end faces of the honeycomb structure portion 10 or the honeycomb structure 20 is more likely to be improved. The ratio of 99.9% or less can allow the difference between heat capacities of the low porosity portion 4 and the portion 5 other than the low porosity portion 4 of the honeycomb structure portion 10 to be reduced, so that it is possible to avoid the occurrence of local stress concentration at a boundary between the low porosity portion 4 and the portion 5 other than the low porosity portion 4. The ratio is more preferably 23% or more and 90% or less, and even more preferably 43% or more and 70% or less.

The average porosity (AP2) of the portion 5 other than the low porosity portion 4 is an arithmetic average of the porosities measured at three positions in total: the end face positions (two positions) on both sides of the portion 5 other than the low porosity portion 4 of the honeycomb structure portion 10; and the central position (one position) in the flow path length direction of the position 5 other than the low porosity portion 4. The porosity is determined by cutting the portion 5 other than the low porosity portion 4 of the honeycomb structure portion 10 in the radial direction so as to obtain porosity measuring samples (cut bodies) at the respective positions, and measuring the porosity at the geometric center position of each end face of the porosity measuring samples (cut bodies).

The average porosity (AP1) of the low porosity portion 4 refers to an arithmetic average value of porosities measured at three positions: the end face positions on both sides of the low porosity portion 4 (two positions: one of these two positions is the same as the end face position of the honeycomb structure portion 10); and the central position (one position) in the flow path length direction of the low porosity portion 4. The porosity is determined by cutting the low porosity portion 4 in the radial direction so as to obtain porosity measuring samples (cut bodies) at the respective positions, and measuring the porosity at the geometric center positions of each end face of the porosity measuring samples (cut bodies).

The average porosity (AP1) of the low porosity portion 4 is preferably 0.1% or more and 40% or less. The average porosity (AP1) of the low porosity portion 4 of 0.1% or more can allow the difference between heat capacities of the low porosity portion 4 and the portion 5 other than the low porosity portion 4 of the honeycomb structure portion 10 to be reduced, so that the occurrence of the local stress concentration at the boundary between the low porosity portion 4 and the portion 5 other than the low porosity portion 4 can be avoided. The average porosity (AP1) of the low porosity portion 4 of 40% or less can allow the difference between the heat capacity of the end region of the honeycomb structure portion 10 and the heat capacity of the other portions to be sufficiently maintained, leading to an improved effect of suppressing the cracks generated at the end faces. The average porosity (AP1) of the low porosity portion 4 is more preferably 3.9% or more and 30% or less, and even more preferably 12% or more and 22% or less.

The low porosity portion 4 can contain ceramics in the partition wall 13. The inclusion of the ceramics in the partition wall 13 may refer to, for example, a form where the ceramics is present on the surface of the partition wall, or for example a form where a layer made of silica is present on the surface of the partition wall. The ceramics is typically silica, but other examples include cordierite, silicon carbide, mullite, alumina, and zirconia. Also, the ceramics may include a plurality of materials.

It is preferable that the partition wall 13 of the low porosity portion 4 contain a larger amount of oxide ceramics and/or silicon carbide than the partition wall of the portion 5 other than the low porosity portion 4. The phrase “contain a larger amount of oxide ceramics and/or silicon carbide” means that the content (mass ratio) of the oxide ceramics and/or silicon carbide is higher. With such a composition, the porosity of the partition wall can be controlled, and the low porosity portion of this specification can be easily formed. Examples of oxide ceramics include, but not limited to, cordierite, mullite, alumina, zirconia, and the like. These may be used alone or in combination of two or more.

It is preferable that the porosity of the low porosity portion 4 gradually increases from the end face to the center of the honeycomb structure portion 10 in the flow path length direction. This can lead to a gentle change in heat capacity in the flow path length direction of the honeycomb structure portion 10, so that the occurrence of the local stress concentration at the boundary between the low porosity portion 4 and the portion 5 other than the low porosity portion 4 can be avoided. The phrase “the porosity of the low porosity portion 4 gradually increases from the end face to the center of the honeycomb structure portion 10 in the flow path length direction” means that as with the measurement positions and measurement method of the average porosity (AP1) of the low porosity portion 4 as described above, each porosity measured at the three positions of the low porosity portion 4 gradually increases from the end face to the center of the honeycomb structure portion 10 in the flow path length direction. However, the porosity of the low porosity portion 4 may be constant in the flow path length direction.

It is preferable that a strength of the low porosity portion 4 is higher than an average strength of the whole honeycomb structure portion 10. This can suppress the cracks generated at the end faces because the strength of each end face is increased. The average strength of the whole honeycomb structure 10 is an arithmetic average value of the strengths measured at five positions of the honeycomb structure portion 10. The portions where the strengths are measured to obtain the average strength are five positions in total: end face positions (two positions) on both sides of the honeycomb structure portion 10; and positions (two positions) each from the end faces on both sides to the center in the flow path length direction by ¼ of the total length of the honeycomb structure portion 10; and a central position (one position) in the flow path length direction of the honeycomb structure portion 10. The strength is determined by cutting the honeycomb structure portion 10 in the radial direction so as to obtain samples (cut bodies) for measuring the strength at each position, and measuring the strength at the geometric center position of each end face of the samples (cut bodies). It should be noted that the strength may be, for example, four-point bending strength, or the like. The four-point bending strength is a value measured by the “bending test” in accordance with JIS R 1601. The strength of the low porosity portion 4 may be, for example, 1.01 to 2.04 times the average strength of the whole honeycomb structure portion 10.

The low porosity portion 4 preferably has a Young’s modulus higher than an average Young’s modulus of the whole honeycomb structure portion 10. This can reduce an amount of deformation of the end portion regions due to thermal expansion when the end portion regions of the honeycomb structure 10 are cooled and contracted by a fluid such as an exhaust gas, so that the cracks generated at the end faces can be further suppressed. The average Young’s modulus of the whole honeycomb structure 10 is an arithmetic average value of the Young’s moduli measured at five positions of the honeycomb structure portion 10. The portions where the Young’s moduli are measured to obtain the average Young’s modulus are five positions in total: end face positions (two positions) on both sides of the honeycomb structure portion 10; and positions (two positions) each from the end faces on both sides to the center in the flow path length direction by ¼ of the total length of the honeycomb structure portion 10; and a central position (one position) in the flow path length direction of the honeycomb structure portion 10. The Young’s modulus is determined by cutting the honeycomb structure portion 10 in the radial direction so as to obtain samples (cut bodies) for measuring the Young’s modulus at each position, and measuring the Young’s modulus at the geometric center position of each end face of the samples (cut bodies). It should be noted that the Young’s modulus can be measured by the “bending resonance method” in accordance with JIS R 1602. The Young’s modulus of the low porosity portion 4 may be, for example, 1.01 to 1.76 times the average Young’s modulus of the whole honeycomb structure portion 10.

The low porosity portion 4 preferably has a thermal expansion coefficient higher than an average thermal expansion coefficient of the whole honeycomb structure portion 10. This can reduce an amount of deformation of the end portion regions due to thermal expansion when the end portion regions of the honeycomb structure 10 are cooled and contracted by a fluid such as an exhaust gas, so that the cracks generated at the end surfaces can be further suppressed. The average thermal expansion coefficient of the whole honeycomb structure 10 is an arithmetic average value of the thermal expansion coefficients measured at five positions of the honeycomb structure portion 10. The portions where the thermal expansion coefficients are measured to obtain the average thermal expansion coefficient are five positions in total: end face positions (two positions) on both sides of the honeycomb structure portion 10; and positions (two positions) each from the end faces on both sides to the center in the flow path length direction by ¼ of the total length of the honeycomb structure portion 10; and a central position (one position) in the flow path length direction of the honeycomb structure portion 10. The thermal expansion coefficient is determined by cutting the honeycomb structure portion 10 in the radial direction so as to obtain samples (cut bodies) for measuring the thermal expansion coefficient at each position, and measuring the thermal expansion coefficient at the geometric center position of each end face of the samples (cut bodies). The thermal expansion coefficient refers to a linear thermal expansion coefficient at a temperature of from 40 to 800° C., measured by a method in accordance with JIS R 1618: 2002. As a thermal expansion meter, “TD 5000 S (trade name)” from Bruker AXS can be used. The thermal expansion coefficient of the low porosity portion 4 may be, for example, 4.3 to 5.0 ppm/K.

It is preferable that the partition wall 13 of the low porosity portion 4 has a thickness higher than an average thickness of the partition wall 13 of the whole honeycomb structure portion 10. This can lead to an increased heat capacity of each end portion region, so that the cracks generated at the end faces can be further suppressed. As described above, in the present invention, the thickness of the partition wall 13 is defined as a length of a portion passing through the partition wall 13, among line segments connecting the centers of gravity of adjacent cells 16, in the cross section perpendicular to the extending direction of the cells 16. The average thickness of the whole honeycomb structure 10 is an arithmetic average value of the thicknesses measured at five positions of the honeycomb structure portion 10. The portions where the thicknesses are measured to obtain the average thickness are five positions in total: end face positions (two positions) on both sides of the honeycomb structure portion 10; and positions (two positions) each from the end faces on both sides to the center in the flow path length direction by ¼ of the total length of the honeycomb structure portion 10; and a central position (one position) in the flow path length direction of the honeycomb structure portion 10. The honeycomb structure portion 10 is cut in the radial direction so as to obtain samples (cut bodies) for measuring the thickness at each position. The thickness is measured at each end face of the samples (cut bodies). The line segment defined when measuring the thickness of the partition wall 13 (the line segment connecting the centers of gravity of adjacent cells 16) passes the geometric center position of the end face of each sample (cut body) and is a part of a straight line perpendicular to the partition wall 13. For example, when the shape of each cell 16 in the cross section perpendicular to the extending direction of the cells 16 is hexagonal, three lines can be defined as such a straight line, and the thickness of the partition wall 13 is measured along each of these three straight lines. Similarly, when the shape of each cell 16 is rectangular, for example, two lines can be defined as such a straight line, and the thickness of the partition wall 13 is measured along each of these two lines. The thickness of the partition wall 13 is determined by dividing the sample into 10 equal parts in the radial direction or width direction at the end face of each sample (cut body) except for the outer peripheral wall 12, and measuring the thicknesses at 11 points where the above straight lines and the partition wall 13 intersect at the boundary or around the boundary of the 10 equal parts. The thickness of the partition wall 13 of the low porosity portion 4 can be, for example, 0.105 to 0.305 mm.

The low porosity portion 4 preferably has a volume resistivity (Ω·cm) lower than an average volume resistivity of the whole honeycomb structure portion 10. This can lead to easy flowing of current through the low porosity portion 4, resulting in a more uniform temperature rise of the honeycomb structure portion 10 during heating due to electrical conduction. The average volume resistivity of the whole honeycomb structure 10 is an arithmetic average value of the volume resistivities measured at five positions of the honeycomb structure portion 10. The portions where the volume resistivities are measured to obtain the average volume resistivity are five positions in total: end face positions (two positions) on both sides of the honeycomb structure portion 10; and positions (two positions) each from the end faces on both sides to the center in the flow path length direction by ¼ of the total length of the honeycomb structure portion 10; and a central position (one position) in the flow path length direction of the honeycomb structure portion 10. The volume resistivity is determined by cutting the honeycomb structure portion 10 in the radial direction so as to obtain samples (cut bodies) for measuring the volume resistivity at each position, and measuring the volume resistivity at the geometric center position of each end face of the samples (cut bodies). The volume resistivity is a value measured at 25° C. by the four-terminal method. The volume resistivity of the low porosity portion 4 can be, for example, 0.1 to 200 Ω·cm.

### (2. Electrode Layer)

The honeycomb structure 20 is provided with a pair of electrode layers 14a, 14b on an outer surface of the outer peripheral wall 12, so as to face each other across a central axis of the honeycomb structure portion 10. It is preferable that the pair of electrode layers are provided so as to extend in a form of a band in the flow path direction of the cells. Each of the electrode layers 14a, 14b preferably extends over 80% or more of the total length (a distance between the both end faces) of the honeycomb structure portion 10, more preferably over 90% or more, even more preferably over the total length, from the viewpoint that the current can easily spread in the axial direction of the electrode layers 14a, 14b.

Each of the electrode layers 14a, 14b has a thickness of from 0.01 to 5 mm, and more preferably from 0.01 to 3 mm. Such a range of the thickness can improve uniform heat generation and ensure thermal shock resistance. The thickness of each of the electrode layers 14a, 14b is defined as a thickness of an outer surface of each of the electrode layers 14a, 14b in a normal direction relative to a tangent line at a point where the thickness is to be measured, when the point to be measured is observed in the cross section perpendicular to the extending direction of the cells 16.

By making the volume resistivity of each of the electrode layers 14a, 14b lower than the average volume resistivity of the whole honeycomb structure portion 10, the electricity tends to flow preferentially to the electrode layers 14a, 14b, and the electricity tends to spread in the flow direction and in the circumferential direction of the cells 16 during heating due to electrical conduction. The volume resistivity of the electrode layers 14a, 14b is preferably ⅒ or less, and more preferably 1/20 or less, and even more preferably 1/30 or less of the average volume resistivity of the whole honeycomb structure portion 10. However, if the difference between the volume resistivities of both is too large, the electric current will concentrate between the end portions of the facing electrode portions, and the heat generation of the honeycomb structure portion 10 will be biased. Therefore, the volume resistivity of the electrode portions 14a, 14b is preferably 1/200 or more, and more preferably 1/150 or more, and even more preferably 1/100 or more of the average volume resistivity of the whole honeycomb structure 10. The volume resistivity of the electrode layers 14a, 14b is a value measured at 25° C. by the four-terminal method.

Electrode layers 14a, 14b can be made of conductive ceramics, a metal, or a composite material (cermet) of a metal and conductive ceramics. Examples of the metal include an elemental metal, for example, Cr, Fe, Co, Ni, Si, or Ti, or an alloy containing at least one metal selected from the group consisting of those metals. Non-limiting examples of the conductive ceramics include silicon carbide (SiC), and metal compounds such as metal silicides such as tantalum silicide (TaSi₂) and chromium silicide (CrSi₂). Specific examples of the composite (cermet) of a metal and conductive ceramics include composites of metal silicon and silicon carbide, composites of metal silicides such as tantalum silicide and chromium silicide, metal silicon and silicon carbide, and further, from the viewpoint of thermal expansion reduction, composites obtained by adding one or more insulating ceramics such as alumina, mullite, zirconia, cordierite, silicon nitride and aluminum nitride to one or more of the metals as listed above.

### Electrically Heating Catalyst Support

The electrically heating catalyst support 30 includes the honeycomb structure 20 and a catalyst supported onto the honeycomb structure portion 10 of the honeycomb structure 20.

A fluid such as an exhaust gas from a motor vehicle can flow through the flow paths of the cells 16. Examples of the catalyst supported onto the electrically heating catalyst support 30 include noble metal-based catalysts and catalysts other than those. Illustrative examples of the noble metal catalysts include three-way catalysts and oxidation catalysts having a noble metal such as platinum (Pt), palladium (Pd), and rhodium (Rh) supported on surfaces of alumina pores, and containing a co-catalyst such as ceria and zirconia; or lean NOx trap catalysts (LNT catalysts) containing an alkaline earth metal and platinum as storage components for nitrogen oxides (NOx). Examples of catalysts that do not use noble metals include NOx catalytic reduction catalysts (SCR catalysts) containing copper-substituted or iron-substituted zeolites, and the like. Further, two or more types of catalysts selected from the group consisting of those catalysts may be used. A method of supporting the catalyst is also not particularly limited, and it can be carried out according to the conventional method of supporting the catalyst on the honeycomb structure 20.

It is preferable that a catalyst-supported thickness of the low porosity portion 4 provided in the end portion region of the honeycomb structure portion 10 is lower than an average catalyst-supported thickness of the whole honeycomb structure portion 10. In other words, it is preferable that the catalyst-supported thickness of the portion 5 other than the low porosity portion 4 of the honeycomb structure portion 10 is higher than the catalyst-supported thickness of the low porosity portion 4. Since the portion 5 of the honeycomb structure portion 10 other than the low porosity portion 4 tends to reach a higher temperature during heating due to electrical conduction, the higher catalyst-supported thickness of the portion 5 other than the low porosity portion 4 can improve a purification rate of harmful components of an exhaust gas at cold start of an engine.

The average catalyst-supported thickness of the whole honeycomb structure 10 is an arithmetic average value of the catalyst-supported thicknesses measured at three positions of the honeycomb structure 10: end face positions (two positions) on both sides of the honeycomb structure 10; and the central position (one position) in the flow path length direction of the honeycomb structure. The catalyst-supported thickness is a value measured with a scanning electron microscope (SEM). The catalyst-supported thickness is determined by cutting it in the radial direction so as to obtain samples (cut bodies) for measuring the catalyst-supported thickness at each position, and measuring the catalyst-supported thickness at the geometrical center position of each end face of the samples (cut bodies) for measuring the catalyst-supported thickness. The catalyst-supported thickness is obtained by observing the cross-sectional portions at the respective measurement positions of the honeycomb structure portion 10 with a scanning electron microscope (SEM), and acquiring SEM images. It should be noted that the SEM image is to be observed by magnifying it 200 times. Here, the catalyst-supported thickness is defined as a length of a line segment passing through the catalyst-supported portion, among line segments connecting the centers of gravity of adjacent cells 16 in a cross section perpendicular to the extending direction of the cells 16. In other words, the catalyst-supported thickness is defined as a length excluding the cell 16 portions and the partition wall 13 portion from the line segment connecting the centers of gravity of the adjacent cells 16 in the cross section perpendicular to the extending direction of the cells 16. It should be noted that the catalyst portions supported on the void portions (inside the pores) of the partition wall 13 are regarded as the partition wall 13.

### Method for Producing Honeycomb Structure and Electrically Heating Catalyst Support

Next, methods for producing the honeycomb structure 20 and the electrically heating catalyst support 30 according to the present invention are described by way of example. In an embodiment, the method for producing the honeycomb structure 20 includes: a step A1 of obtaining an unfired honeycomb structure; and a step A2 of firing the unfired honeycomb structure to obtain a honeycomb structure 20. In other embodiments, an electrode layer forming paste may be calcined and then attached to the honeycomb structure portion 10 to form the honeycomb structure 20.

The step A1 is to produce a honeycomb formed body which is a precursor of the honeycomb structure, applying the electrode layer forming paste to a side surface of the honeycomb formed body to obtain an unfired honeycomb structure with electrode layer forming paste.

To produce the pillar shaped honeycomb formed body, first, a forming raw material is prepared by adding to silicon carbide powder (silicon carbide), metal silicon powder (metal silicon), a binder(s), a surfactant(s), a pore former, a water catalyst supporting amount and the like. The addition is preferably such that a mass of the metal silicon is from 10 to 40% of the total mass of the silicon carbide powder and the metal silicon. An average particle diameter of silicon carbide particles in the silicon carbide powder is preferably from 3 to 50 µm, and more preferably from 3 to 40 µm. An average particle diameter of the metal silicon (metal silicon powder) is preferably from 2 to 35 µm. The average particle diameter of each of the silicon carbide particles and the metal silicon (metal silicon powder) refers to an arithmetic average diameter on a volume basis when frequency distribution of particle diameters is measured by the laser diffraction method.

Examples of the binder include methyl cellulose, hydroxypropylmethyl cellulose, hydroxypropoxyl cellulose, hydroxyethyl cellulose, carboxymethyl cellulose, and polyvinyl alcohol. Among them, it is preferable to use methyl cellulose in combination with hydroxypropoxyl cellulose. A content of the binder is preferably from 2.0 to 10.0 parts by mass when the total mass of the silicon carbide powder and the metal silicon powder is 100 parts by mass.

A content of water is preferably from 20 to 60 parts by mass when the total mass of the silicon carbide powder and the metal silicon powder is 100 parts by mass.

The surfactant that can be used herein include ethylene glycol, dextrin, fatty acid soaps, and polyalcohol, and the like. These may be used alone or in combination of two or more. A content of the surfactant is preferably from 0.1 to 2.0 parts by mass when the total mass of the silicon carbide powder and the metal silicon powder is 100 parts by mass.

The pore former is not particularly limited as long as it forms pores after firing. Examples of the pore former include graphite, starch, foamed resins, water-absorbent resins, silica gel, and the like. A content of the pore former is preferably from 0.5 to 10.0 parts by mass when the total mass of the silicon carbide powder and the metal silicon powder is 100 parts by mass. An average particle diameter of the pore former is preferably from 10 to 30 µm. The average particle diameter of the pore former refers to an arithmetic average diameter on a volume basis when frequency distribution of particle diameters is measured by the laser diffraction method. If the pore former is the water-absorbent resin, the average particle diameter of the pore former refers to an average particle diameter after water absorption.

The resulting forming raw material is then kneaded to form a green body, and the green body is then extruded to produce a honeycomb formed body. For the extrusion, a die having a desired overall shape, cell shape, wall thickness, cell density, and the like can be used. Subsequently, the resulting honeycomb formed body is preferably dried. If the length of the honeycomb formed body in the direction of the central flow path length is not the desired length, both end faces of the honeycomb formed body can be cut to have the desired length. The honeycomb formed body after drying is called a honeycomb dried body.

Subsequently, an electrode layer forming paste is prepared in order to form the electrode layers. The electrode layer forming paste can be formed by adding various additives to the raw material powder (metal powder, glass powder, and the like) formulated according to required characteristics of the electrode layers, and kneading them. Powder of a metal such as stainless steel can be used as the metal powder.

The resulting electrode layer forming paste is applied to the side surface of the honeycomb dried body to obtain an unfired honeycomb structure with electrode layer forming paste. The applying of the electrode layer forming paste to the honeycomb formed body can be carried out in accordance with the known method for producing the honeycomb structure 20.

As a variation of the method for producing the honeycomb structure 20, the honeycomb dried body may be fired before applying the electrode layer forming paste in the step A1. That is, in this variation, the honeycomb dried body is fired to produce a honeycomb fired body, and the electrode layer forming paste is applied to the honeycomb fired body.

In the step A2, the unfired honeycomb structure is fired to obtain a honeycomb structure. The filing can be carried out under conditions: in an inert gas atmosphere or an air atmosphere, at an atmospheric pressure or less, at a firing temperature of from 1150 to 1350° C., for a firing time of from 0.1 to 50 hours. The firing atmosphere can be, for example, an inert gas atmosphere, and the pressure during firing can be ambient pressure. In order to decrease the electrical resistance of the honeycomb structure portion 10, it is preferable to decrease the residual oxygen in terms of inhibited oxidation, and it is preferable to create a high vacuum of 1.0 × 10⁻⁴ Pa or more in the atmosphere during sintering and then purge the inert gas before sintering. The inert gas atmosphere includes a N₂ gas atmosphere, a helium gas atmosphere, an argon gas atmosphere, and the like. Before firing, the unfired honeycomb structure may be dried. Further, prior to the firing, degreasing may also be carried out to remove the binder and the like.

The honeycomb structure 20 thus obtained is provided with the low porosity portion 4. The low porosity portion 4 is obtained by pressing the end face side of the honeycomb structure 20 desired to provide the low porosity portion 4 against a sponge containing an aqueous solution of colloidal silica, thereby impregnating the portion desired to provide the low porosity portion 4 with the colloidal silica, and then drying it. The step of impregnating with and drying the colloidal silica may be performed once or multiple times. The concentration of the aqueous solution of colloidal silica may be determined according to the target porosity of the low porosity portion, and may be saturated. The aqueous solution of colloidal silica may be impregnated without using the sponge. The drying step for providing the low porosity portion 4 may be natural drying or forced drying by heating. Alternatively, forced drying may be performed after natural drying. The drying conditions for forced drying are preferably heating at 400 to 700° C. for 10 to 60 minutes. The forced drying can further strengthen the chemical bond of the impregnated material. The heating method is not particularly limited, and the forced drying can be performed using an electric furnace, a gas furnace, or the like.

The step of providing the low porosity portion 4 is preferably performed after firing the honeycomb structure 20, but it may be performed after forming the honeycomb structure 20 (formed honeycomb body) or after drying the honeycomb structure 20 (honeycomb dried body).

The method for producing the electrically heating catalyst support 30 supports a catalyst onto the honeycomb structure 20. A method for supporting the catalyst onto the honeycomb structure 20 can be carried out according to a known method for supporting the catalyst onto the honeycomb structure 20. The step of supporting the catalyst onto the honeycomb structure 20 is preferably performed after providing the low porosity portion 4 on the honeycomb structure 20, but it may be carried out by supporting the catalyst onto the honeycomb structure 20 before providing the low porosity portions 4, and then providing the honeycomb structure 20 (electrically heating catalyst support 30) with the low porosity portion 4.

The method for making the catalyst-supported thickness of the low porosity portion 4 of the honeycomb structure 20 thinner than the average catalyst-supported thickness of the whole honeycomb structure 20 includes a method for sucking a catalyst slurry from the end face side desired to provide the low porosity portion 4 of the honeycomb structure 20 while immersing the end face of the honeycomb structure 20 opposite to the end face desired to provide the low porosity portion 4 in the catalyst slurry, and stopping the suction of the catalyst slurry before the catalyst slurry reaches the low porosity portion 4 of the honeycomb structure 20.

### Exhaust Gas Purifying Device

The exhaust gas purifying device includes: the honeycomb structure 20; electrode terminals 15a, 15b respectively provided on the pair of electrode layers 14a, 14b of the honeycomb structure 20; a metallic can body for holding the honeycomb structure 20. Each of the honeycomb structure 20 and the electrically heating catalyst support 30 according to each of the above embodiments of the present invention can be used in an exhaust gas purifying device. In the exhaust gas purifying device, the honeycomb structure 20 (the electrically heating catalyst support 30) is installed in the middle of an exhaust gas flow path for an exhaust gas from an engine.

The electrode terminals 15a, 15b are provided on the electrode layers 14a, 14b of the honeycomb structure 20, respectively. The electrode terminals 15a, 15b may be a pair of electrode terminals arranged so that one electrode terminal faces the other electrode terminal across the central axis of the honeycomb structure portion 10. As a result, when a voltage is applied to the electrode terminals 15a, 15b, an electric current can be conducted to heat the honeycomb structure portion 10 by Joule heat. Therefore, the honeycomb structure portion 10 can be suitably used as a heater. The voltage to be applied is preferably from 12 to 900 V, and more preferably from 48 to 600 V, although the voltage to be applied may be changed as needed.

The electrode terminals 15a, 15b may be made of a metal. Although single metals and alloys may be used as the metal, it is preferable to use alloys containing at least one selected from the group consisting of Cr, Fe, Co, Ni, and Ti, for example, in terms of corrosion resistance, volume resistivity, and linear expansion coefficient, and it is more preferable to use stainless steel and Fe—Ni alloys. The shape and size of each of the electrode terminals 15a, 15b are not particularly limited, and they can be designed according to the size and current conduction performance of the electrically heating catalyst support.

The electrode terminals 15a, 15b may be composed of ceramics. The ceramics include, but not limited to, silicon carbide (SiC), metal compounds such as metal silicides such as tantalum silicide (TaSi₂) and chromium silicide (CrSi₂), and composites containing one or more metals (cermet). Specific examples of cermet include composites of silicon and silicon carbide; composites of metal silicides such as tantalum silicide and chromium silicide, and metal silicon, and silicon carbide; as well as composites obtained by adding one or more insulating ceramics such as alumina, mullite, zirconia, cordierite, silicon nitride, and aluminum nitride to one or more of the above metals in terms of reducing thermal expansion. The material of each of the electrode terminals 15a, 15b may be of the same quality as that of each of the electrode layers 14a, 14b. The electrode terminals 15a, 15b may be formed in a pillar shape.

If the electrode terminals 15a, 15b are made of ceramics, each of tips of them may be joined to a metal terminal. The ceramic terminals and the metal terminals can be joined by means of clamping, welding, conductive adhesives, or the like. The material of the metal terminals includes conductive metals such as iron alloys and nickel alloys.

The metallic can body is a can body made of a metal for holding the honeycomb structure 20. Examples of the metal include, but not limited to, various stainless steels such as chromium-based stainless steel. The use of these metals results in an exhaust gas purifying device having high heat resistance and corrosion resistance. The metallic can body has a hollow portion, and the honeycomb structure 20 is inserted and held at a predetermined position in the hollow portion. The plate thickness of the metal used for the metallic can body is arbitrary, but it may preferably be 1 to 3 mm. The inner surface of the metallic can body may be provided with an insulating layer. The provision of the insulating layer can further enhance the effect of preventing electric leakage when the honeycomb structure 20 is energized. It is preferable to dispose a holding material (mat) made of ceramics between the metallic can body and the honeycomb structure 20. Examples of ceramics include, but not limited to, alumina fibers, mullite fibers, alumina-silica-based ceramic fibers, and the like.

### Method for Producing Exhaust Gas Purifying Device

Next, a method for producing the exhaust gas purifying device according to the present invention will be exemplified. The exhaust gas purifying device includes: the honeycomb structure 20 as described above; the electrode terminals 15a, 15b provided on the pair of electrode layers 14a, 14b of the honeycomb structure 20; and the metallic can body for holding the honeycomb structure 20.

When the electrode terminals 15a, 15b provided on the electrode layers 14a, 14b of the honeycomb structure 20 are made of ceramics, first, an electrode terminal forming paste for forming the electrode terminals 15a, 15b is prepared. The electrode terminal forming paste can be formed by appropriately adding various additives to ceramic powder blended according to required characteristics of the electrode terminals 15a, 15b and kneading them. The prepared electrode terminal forming paste can be then provided on the electrode layers 14a, 14b of the honeycomb structure 20 in a pillar shape.

The step of providing the ceramic electrode terminals 15a, 15b is preferably performed after drying the honeycomb structure 20 (honeycomb dried body), but it may also be performed after firing the honeycomb structure 20. When the electrode terminals 15a, 15b are provided after drying the honeycomb structure 20 (honeycomb dried body), the electrode terminals 15a, 15b can also be fired at the same time in the firing step of the honeycomb structure 20. When the electrode terminals 15a, 15b are provided after firing the honeycomb structure 20, the honeycomb structure 20 with the electrode terminals 15a, 15b can be fired again. After firing only the ceramic electrode terminals 15a, 15b, they can be provided on the electrode layers 14a, 14b of the honeycomb structure 20. The firing conditions for the ceramic electrode terminals 15a, 15b can be as follows: in an inert gas atmosphere or an atmospheric pressure, under atmospheric pressure, at a firing temperature of 1150 to 1350° C., and for a firing time of 0.1 to 50 hours.

When the metal terminals are used as the electrode terminals 15a, 15b, the metal electrode terminals 15a, 15b are fixed on the electrode layers 14a, 14b of the honeycomb structure 20, respectively. Examples of the fixing method include laser welding, ultrasonic welding, and thermal spraying. The step of providing the metal terminals on the electrode layers 14a, 14b of the honeycomb structure 20 can be performed after firing the honeycomb structure 20.

The method for holding the honeycomb structure 20 in the metallic can body can be performed according to a known method for holding the honeycomb structure 20 in the metallic can body. Examples of the method include a method for holding the honeycomb structure 20 having a ceramic holding material (mat) arranged on the outer peripheral wall 12 and the electrode layers 14a, 14b of the honeycomb structure 20, in an inner side of the metallic can body. It should be noted that the holding material (mat) made of ceramics may not be arranged at portions of the electrode layers 14a, 14b on which the electrode terminals 15a, 15b are located.

### EXAMPLES

### Example 1

### (1. Preparation of Green Body)

A ceramic raw material was prepared by mixing silicon carbide (SiC) powder and metal silicon (Si) powder at a mass ratio of 80:20. To the ceramic raw material were the added hydroxypropylmethyl cellulose as a binder, a water absorbing resin as a pore former, and water to obtain a forming raw material. The forming raw material was then kneaded by a vacuum kneader to prepare a cylindrical green body. The binder content was 7 parts by mass when the total of silicon carbide (SiC) powder and metal silicon (Si) powder was 100 parts by mass. The content of the pore former was 3 parts by mass when the total of silicon carbide (SiC) powder and metal silicon (Si) powder was 100 parts by mass. The content of water was 42 parts by mass when the total of silicon carbide (SiC) powder and metal silicon (Si) powder was 100 parts by mass. The silicon carbide powder had an average particle diameter of 20 µm, and the metal silicon powder had an average particle diameter of 6 µm. Also, the pore former had an average particle diameter of 20 µm. The average particle diameter of each of the silicon carbide powder, metal silicon powder and pore former refers to an arithmetic average diameter on a volume basis when the frequency distribution of particle diameters is measured by a laser diffraction method.

### (2. Preparation of Honeycomb Dried Body)

The obtained cylindrical green body was formed using an extruding machine having a die attached to the tip to obtain a cylindrical honeycomb formed body in which each cell had a hexagonal shape in a cross section perpendicular to the flow path direction of the cells. After the honeycomb formed body was dried by high-frequency dielectric heating, it was dried at 120° C. for 2 hours using a hot air dryer to prepare a honeycomb dried body.

### (3. Preparation and Application of Electrode Layer Forming Paste)

Metal silicon (Si) powder, silicon carbide (SiC) powder, methyl cellulose, glycerin, and water were mixed together in a rotation and revolution agitator to prepare an electrode layer forming paste. The Si powder and the SiC powder were blended in a volume ratio of Si powder:SiC powder = 40:60. Further, when the total of Si powder and SiC powder was 100 parts by mass, methyl cellulose was 0.5 parts by mass, glycerin was 10 parts by mass, and water was 38 parts by mass. The metal silicon powder had an average particle diameter of 6 µm. The silicon carbide powder had an average particle diameter of 35 µm. These average particle diameters refer to arithmetic average diameters on a volume basis when the frequency distribution of particle diameters is measured by a laser diffraction method.

The electrode layer forming paste was then applied to the honeycomb dried body by a curved surface printing machine in an appropriate area and film thickness.

### (4. Production of Honeycomb Fired Body)

The honeycomb dried body with the electrode layer forming paste was fired in an Ar atmosphere at 1400° C. for 3 hours to obtain a honeycomb structure 20.

### (5. Formation of Low Porosity Portion)

A sponge made of polyvinyl alcohol was then impregnated with an aqueous dispersion of colloidal silica having a concentration of 40% by mass. One end face and the other end face of the honeycomb structure 20 were pressed against the sponge containing the aqueous solution of colloidal silica to impregnate the sponge with colloidal silica. It was then dried in an electric furnace at 450° C. for 30 minutes to form the low porosity portion 4, thereby producing the honeycomb structures 20 for samples. Each of the resulting samples was a cylindrical honeycomb structure 20 having a diameter of 93 mm and a flow path length of 65 mm. The cell density of each sample was 930 cells/cm² and the thickness of the partition wall 13 of each sample was 0.15 mm. The cross sectional shape of each cell 16 was hexagonal, and the volume resistivity of each sample was 2.0 Ω·cm.

### Examples 2 to 10

Each honeycomb structure 20 for a sample was produced by the same method as that of Example 1, with the exception that the extension width of each low porosity portion 4 and the porosity of each low porosity portion 4 were changed as shown in Tables 1-1 and 1-2.

### Examples 11 to 16

Each honeycomb structure 20 for a sample was produced by the same method as that of Example 1, with the exception that the low porosity portion 4 was formed only on one end surface (the inlet side in the gas flow direction) of the honeycomb structure 20, and the extension width of the low porosity portion 4 was changed as shown in Tables 1-1 and 1-2.

### Examples 17 to 19

Each honeycomb structure 20 for a sample was produced by the same method as that of Example 1, with the exception that the low porosity portion 4 was formed only on one end surface (the inlet side in the gas flow direction) of the honeycomb structure 20, and the porosity of the low porosity portion 4 was changed as shown in Tables 1-1 and 1-2.

### Example 20

Any honeycomb structure 20 for a sample was produced by the same method as that of Example 1, with the exception that the low porosity portion 4 was formed only on one end surface (the inlet side in the gas flow direction) of the honeycomb structure 20, and the porosity of the low porosity portion 4 was gradually increased from the one end surface to the center in the flow path length direction as shown in Tables 1-1 and 1-2.

### Examples 21 to 25

Each honeycomb structure 20 for a sample was produced by the same method as that of Example 1, with the exception that the low porosity portion 4 was formed only on one end surface (the inlet side in the gas flow direction) of the honeycomb structure 20, and the thermal expansion coefficient of the low porosity portion 4 was changed as shown in Tables 1-1 and 1-2. For the change of the thermal expansion coefficient of the low porosity portion 4, the dispersions contained in the sponge pressed against one end face of the honeycomb structure 20 were, in addition to the aqueous dispersion of colloidal silica, a dispersion obtained by adding cordierite powder for Example 21, silicon carbide powder for Example 22, mullite powder for Example 23, alumina powder for Example 24, and oxide ceramic powder as zirconia powder or silicon carbide powder for Example 25. The ratio of amounts of colloidal silica and oxide ceramic powder or silicon carbide powder added was adjusted so that the volume ratio of silica and oxide ceramic or silicon carbide in the low porosity portion after the heat treatment was 1:1.

### Example 26

Any honeycomb structure 20 for a sample was produced by the same method as that of Example 1, with the exception that the low porosity portion 4 was formed only on the other end face (the outlet side in the gas flow direction) of the honeycomb structure 20.

### Comparative Examples 1 and 2

Any honeycomb structure 20 for a sample was produced by the same method as that of Example 1, with the exception that the low porosity portion 4 was not formed.

### (Heating and Cooling Test 1)

Using a propane gas burner tester equipped with a metal case for housing each honeycomb structure 20 (each sample) and a propane gas burner capable of feeding a heating gas into the metal case, a heating and cooling test 1 was conducted for the samples of Examples 1 to 25 and Comparative Example 1 as shown in Tables 1-1 and 1-2 below.

As described above, Examples 1 to 25 are the honeycomb structures 20 having the low porosity portion 4 only on the end face (one end face) on the fluid (gas) inlet side, or having the low porosity portions 4 on the end face on the fluid (gas) inlet side and the end face on the fluid (gas) outlet side (one end face and the other end face), in which the parameters as shown in Tables 1-1 and 1-2 such as the extension width of the low porosity portion 4 are suitably set to be different. Comparative Example 1 is the honeycomb structure 20 having no low porosity portion 4.

The heating gas was a combustion gas generated by burning the propane gas with the propane gas burner. Then, the thermal shock resistance was evaluated by confirming whether or not cracks were generated in the samples by the heating and cooling test 1 as described above. Specifically, first, each sample was housed (canned) in the metal case of the propane gas burner tester. The gas (combustion gas) heated by the propane gas burner was fed into the metal case so that the gas passed through each sample.

The temperature condition of the heating gas flowing into the metal case (inlet gas temperature condition) was set as follows. First, the temperature was increased to the specified temperature in 10 minutes, maintained at the specified temperature for 5 minutes, cooled to 100° C. in 3 minutes, and maintained at 100° C. for 10 minutes. Such a series of operations of increasing, maintaining, cooling, and maintaining the temperature is refer to as a “heating and cooling operation”. Subsequently, cracks in each sample were confirmed with a microscope. The above “heating and cooling operation” was then repeated while increasing the specified temperature from 800° C. by 50° C. The specified temperature was increased by 50° C. until cracks were generated in each sample. As the specified temperature increases, the temperature of the honeycomb structure 20 at the start of cooling increases, so that the end face (one end face) of the honeycomb structure 20 on the gas inlet side is rapidly cooled during the cooling, and the generated stress increases. In the heating and cooling test 1, cracks were generated at the end face (one end face) on the gas inlet side for all the samples. In Tables 1-1 and 1-2, the column of “Thermal Shock Resistance” shows the specified temperature when cracks were generated in each sample in the thermal shock resistance test 1.

TABLE 1-1

| | | End Face Having Low Porosity Portion In represents inlet side of fluid, Out represents outlet side of fluid | End Face Having Low Porosity Portion In represents inlet side of fluid, Out represents outlet side of fluid s | Extension Width of Low Porosity Portion | Extension Width of Low Porosity Portion/Total Length of Honeycomb Structure Portion | Porosity of Low Porosity Portion | Average Porosity of Whole | Porosity of Portion Other Than Low Porosity Portion | (AP2-AP1/AP2)*100 (AP1): Average Porosity of Low Porosity Portion (AP2): Average Porosity of Portion Other Than Low Porosity Portion |
|---|---|---|---|---|---|---|---|---|---|
| Unit | | - | - | mm | % | % | % | % | % |
| Example | 1 | ln/Out | ln | 3 | 4.6 | 32.0 | 35.8 | 39.0 | 18.0 |
| | | | Out | 3 | 4.6 | 30.0 | | | 23.0 |
| Example | 2 | ln/Out | ln | 3 | 4.6 | 20.0 | 31.8 | 39.0 | 48.7 |
| | | | Out | 3 | 4.6 | 21.9 | | | 43.9 |
| Example | 3 | ln/Out | ln | 3 | 4.6 | 33.7 | 37.4 | 39.0 | 13.5 |
| | | | Out | 3 | 4.6 | 36.2 | | | 7.3 |
| Example | 4 | ln/Out | ln | 3 | 4.6 | 32.2 | 34.9 | 39.0 | 17.4 |
| | | | Out | 3 | 4.6 | 25.3 | | | 35.1 |
| Example | 5 | ln/Out | ln | 5 | 7.7 | 35.9 | 37.3 | 39.0 | 7.9 |
| | | | Out | 5 | 7.7 | 33.4 | | | 14.4 |
| Example | 6 | ln/Out | ln | 5 | 7.7 | 28.1 | 34.3 | 39.0 | 28.1 |
| | | | Out | 5 | 7.7 | 26.3 | | | 32.5 |
| Example | 7 | ln/Out | ln | 5 | 7.7 | 37.4 | 37.8 | 39.0 | 4.1 |
| | | | Out | 5 | 7.7 | 34.8 | | | 10.8 |
| Example | 8 | ln/Out | ln | 10 | 15.4 | 36.0 | 37.2 | 39.0 | 7.6 |
| | | | Out | 10 | 15.4 | 33.1 | | | 15.1 |
| Example | 9 | ln/Out | ln | 10 | 15.4 | 35.1 | 37.7 | 39.0 | 10.0 |
| | | | Out | 10 | 15.4 | 36.3 | | | 6.9 |
| Example | 10 | ln/Out | ln | 10 | 15.4 | 36.4 | 37.3 | 39.0 | 6.6 |
| | | | Out | 10 | 15.4 | 33.3 | | | 14.6 |
| Example | 11 | ln | ln | 0.3 | 0.5 | 32.0 | 37.6 | 39.0 | 18.0 |
| Example | 12 | ln | ln | 0.6 | 0.9 | 32.0 | 37.6 | 39.0 | 18.0 |
| Example | 13 | ln | ln | 3.1 | 4.8 | 32.0 | 37.6 | 39.0 | 18.0 |
| Example | 14 | ln | ln | 9 | 13.8 | 32.0 | 37.6 | 39.0 | 18.0 |
| Example | 15 | ln | ln | 18 | 27.7 | 32.0 | 36.2 | 39.0 | 18.0 |
| Example | 16 | ln | ln | 28 | 43.1 | 32.0 | 36.2 | 39.0 | 18.0 |
| Example | 17 | ln | ln | 3 | 4.6 | 1.0 | 31.4 | 39.0 | 97.4 |
| Example | 18 | ln | ln | 3 | 4.6 | 15.0 | 34.2 | 39.0 | 61.5 |
| Example | 19 | ln | ln | 3 | 4.6 | 25.0 | 36.2 | 39.0 | 35.9 |
| Example | 20 | ln | ln | 10 | 15.4 | ▪End Face: 15 ▪5 mm from End Face: 20 ▪10 mm from End Face: 25 | 35.2 | 39.0 | 48.7 |
| Example | 21 | ln | ln | 3 | 4.6 | 24.5 | 36.1 | 39.0 | 37.2 |
| Example | 22 | ln | ln | 3 | 4.6 | 24.7 | 36.1 | 39.0 | 36.6 |
| Example | 23 | ln | ln | 3 | 4.6 | 24.3 | 36.1 | 39.0 | 37.8 |
| Example | 24 | ln | ln | 3 | 4.6 | 23.9 | 36.0 | 39.0 | 38.7 |
| Example | 25 | ln | ln | 3 | 4.6 | 24.0 | 36.0 | 39.0 | 38.4 |
| Comp. | 1 | Non | - | - | - | - | 39.0 | - | - |

TABLE 1-2

| | | Strength of Low Porosity Portion | Strength Ratio [Low Porosity Portion/Whole] | Average Strength of Whole | Young’s Modulus of Low Porosity Portion | Young’s Modulus Ratio [Low Porosity Portion/Whole] | Average Young’s Modulus of Whole | Thermal Expansion Coefficient of Low Porosity Portion | CTE Ratio [Low Porosity Portion/Whole] | Thermal Shock Resistance |
|---|---|---|---|---|---|---|---|---|---|---|
| Unit | | MPa | times | MPa | GPa | times | GPa | ppm/K | times | °C |
| Example | 1 | 45.7 | 1.17 | 42.1 | 67.0 | 1.07 | 62.7 | 4.30 | 1.00 | 1050 |
| | | 47.8 | 1.22 | | 69.3 | 1.11 | | 4.30 | 1.00 | |
| Example | 2 | 59.0 | 1.38 | 46.4 | 81.0 | 1.20 | 67.3 | 4.30 | 1.00 | 1100 |
| | | 56.2 | 1.44 | | 78.6 | 1.17 | | 4.30 | 1.00 | |
| Example | 3 | 43.9 | 1.13 | 40.5 | 65.0 | 1.07 | 60.9 | 4.30 | 1.00 | 1050 |
| | | 41.4 | 1.06 | | 62.2 | 1.02 | | 4.30 | 1.00 | |
| Example | 4 | 45.5 | 1.17 | 43.0 | 66.8 | 1.05 | 63.7 | 4.30 | 1.00 | 1050 |
| | | 52.6 | 1.35 | | 74.6 | 1.17 | | 4.30 | 1.00 | |
| Example | 5 | 41.6 | 1.07 | 40.6 | 62.5 | 1.03 | 61.0 | 4.30 | 1.00 | 1050 |
| | | 44.3 | 1.13 | | 65.4 | 1.07 | | 4.30 | 1.00 | |
| Example | 6 | 49.8 | 1.28 | 43.7 | 71.5 | 1.11 | 64.4 | 4.30 | 1.00 | 1050 |
| | | 51.6 | 1.32 | | 73.5 | 1.14 | | 4.30 | 1.00 | |
| Example | 7 | 40.1 | 1.03 | 40.0 | 60.8 | 1.01 | 60.3 | 4.30 | 1.00 | 1050 |
| | | 42.8 | 1.10 | | 63.8 | 1.06 | | 4.30 | 1.00 | |
| Example | 8 | 41.5 | 1.06 | 40.6 | 62.4 | 1.02 | 61.0 | 4.30 | 1.00 | 1000 |
| | | 44.6 | 1.14 | | 65.7 | 1.08 | | 4.30 | 1.00 | |
| Example | 9 | 42.5 | 1.09 | 40.1 | 63.5 | 1.05 | 60.5 | 4.30 | 1.00 | 1000 |
| | | 41.2 | 1.06 | | 62.1 | 1.03 | | 4.30 | 1.00 | |
| Example | 10 | 41.1 | 1.05 | 40.5 | 61.9 | 1.02 | 60.9 | 4.30 | 1.00 | 1000 |
| | | 44.3 | 1.14 | | 65.5 | 1.08 | | 4.30 | 1.00 | |
| Example | 11 | 45.7 | 1.17 | 40.3 | 67.0 | 1.07 | 60.6 | 4.30 | 1.00 | 1050 |
| Example | 12 | 45.7 | 1.17 | 40.3 | 67.0 | 1.07 | 60.6 | 4.30 | 1.00 | 1050 |
| Example | 13 | 45.7 | 1.17 | 40.3 | 67.0 | 1.07 | 60.6 | 4.30 | 1.00 | 1050 |
| Example | 14 | 45.7 | 1.17 | 40.3 | 67.0 | 1.07 | 60.6 | 4.30 | 1.00 | 1000 |
| Example | 15 | 45.7 | 1.17 | 40.3 | 67.0 | 1.07 | 60.6 | 4.30 | 1.00 | 950 |
| Example | 16 | 45.7 | 1.17 | 40.3 | 67.0 | 1.07 | 60.6 | 4.30 | 1.00 | 900 |
| Example | 17 | 45.7 | 1.17 | 40.3 | 67.0 | 1.07 | 60.6 | 4.30 | 1.00 | 950 |
| Example | 18 | 45.7 | 1.17 | 40.3 | 67.0 | 1.07 | 60.6 | 4.30 | 1.00 | 1050 |
| Example | 19 | 45.7 | 1.17 | 40.3 | 67.0 | 1.07 | 60.6 | 4.30 | 1.00 | 1000 |
| Example | 20 | 45.7 | 1.17 | 42.1 | 67.0 | 1.07 | 62.7 | 4.30 | 1.00 | 1050 |
| Example | 21 | 53.5 | 1.37 | 41.9 | 75.6 | 1.28 | 62.3 | 4.07 | 0.95 | 1000 |
| Example | 22 | 53.2 | 1.36 | 41.8 | 75.3 | 1.28 | 62.3 | 4.29 | 1.00 | 1050 |
| Example | 23 | 53.7 | 1.38 | 41.9 | 75.9 | 1.29 | 62.4 | 4.37 | 1.02 | 1050 |
| Example | 24 | 54.1 | 1.39 | 42.0 | 76.3 | 1.29 | 62.5 | 4.58 | 1.07 | 1050 |
| Example | 25 | 54.0 | 1.38 | 42.0 | 76.1 | 1.29 | 62.4 | 4.91 | 1.14 | 1050 |
| Comp. | 1 | - | - | 39.0 | - | - | 59.0 | 4.30 | - | 850 |

The specified temperature at which cracks were generated in Comparative Example 1 was 850° C., but the specified temperature at which cracks were generated in Examples 1 to 25 was 900° C. or more. It is understood that the results show the superiority of the honeycomb structure 20 having the low porosity portion(s) 4.

In particular, Examples 1 to 15 are examples in which the extension width of the low porosity portion 4 in the flow path length direction of the honeycomb structure portion 10 is 0.3 mm or more and 20 mm or less. In Examples 1 to 15, the specified temperature at which cracks were generated was 950° C. or more, and the effect of suppressing the generation of cracks by setting the extension width to 0.3 mm or more and 20 mm or less is understandable.

Furthermore, Examples 1 to 14 are examples in which the extension width of the low porosity portion 4 in the flow path length direction of the honeycomb structure portion 10 is 0.3 mm or more and 10 mm or less. In Examples 1 to 14, the specified temperature at which cracks were generated was 1000° C. or more, and it is understood that the generation of cracks was more suppressed by setting the extension width to 0.3 mm or more and 10 mm or less. Examples 1 to 7 and Examples 11 to 13 are examples in which the extension width of the low porosity portion 4 in the flow path length direction of the honeycomb structure portion 10 is 0.3 mm or more and 6 mm or less. In Examples 1 to 7 and 11 to 13, the specified temperature at which cracks were generated was 1050° C. or more, and it is understood that the cracking was more suppressed by setting the extension width to 0.3 mm or more and 6 mm or less.

Further, Examples 17 to 19 are examples in which the porosity of the low porosity portion 4 was changed to adjust the ratio of the average porosity of the low porosity portion (AP1) to the average porosity (AP2) of the portion 5 other than the low porosity portion 4 ({(AP2 - AP1) / AP2)} × 100). In each of Examples 17 to 19, the specified temperature at which cracks were generated was 950° C. or more.

Example 20 is an example in which the porosity of the low porosity portion 4 gradually increases from the end face to the center of the honeycomb structure portion 10 in the flow path length direction. The specified temperature at which cracks were generated in Example 20 was 1050° C., and the superiority of gradually increasing the porosity is understandable.

Examples 21 to 25 are examples in which the thermal expansion coefficient of the low porosity portion 4 was adjusted. In Examples 21 to 25, the thermal expansion coefficient of the low porosity portion 4 was set to be equal to or higher than the average thermal expansion coefficient of the whole honeycomb structure portion, so that the specified temperature at which cracks were generated was 1000° C. or higher, and it is understood that the generation of cracks was more suppressed.

### (Heating and Cooling Test 2)

Using a propane gas burner tester equipped with a metal case for housing each honeycomb structure 20 (each sample) and a propane gas burner capable of feeding a heating gas into the metal case, a heating and cooling test 2 was conducted for the samples of Example 26 and Comparative Example 2 as shown in Tables 2-1 and 2-2 below.

Example 26 is the honeycomb structure 20 having the low porosity portion 4 on the end face on the fluid (gas) outlet side, and Tables 2-1 and 2-2 shows the extension width and the porosity and the like of the low porosity portion 4. Comparative Example 2 is the honeycomb structure 20 having no low porosity portion 4.

The heating gas was a combustion gas generated by burning the propane gas with the propane gas burner. Then, the thermal shock resistance was evaluated by confirming whether or not cracks were generated in the samples by the heating and cooling test 2 as described above. Specifically, first, each sample was housed (canned) in the metal case of the propane gas burner tester. The gas (combustion gas) heated by the propane gas burner was fed into the metal case so that the gas passed through each sample.

The temperature condition of the heating gas flowing into the metal case (inlet gas temperature condition) was set as follows. First, the temperature was increased to the specified temperature in 2 minutes, maintained at the specified temperature for 5 minutes, cooled to 100° C. in 10 minutes, and maintained at 100° C. for 5 minutes. Such a series of operations of increasing, maintaining, cooling, and maintaining the temperature is refer to as a “heating and cooling operation”. Subsequently, cracks in each sample were confirmed with a microscope. The above “heating and cooling operation” was then repeated while increasing the specified temperature from 800° C. by 50° C. The specified temperature was increased by 50° C. until cracks were generated in each sample. As the specified temperature increases, the temperature increase steepness becomes large, and the honeycomb structure 20 is rapidly heated, so that the temperature is increased from the gas inlet side in the flow path length direction of the honeycomb structure 20, resulting in an elevated temperature, and the temperature increase is delayed on the gas outlet side in the flow path length direction, resulting in an increased stress generated on the end face on the gas outlet side (the other end face). In the heating and cooling test 2, cracks were generated at the end face (other end face) on the gas outlet side for all the samples. In Tables 2-1 and 2-2, the column of “Thermal Shock Resistance Condition 2” shows the specified temperature when cracks were generated in each sample in the thermal shock resistance test 2.

TABLE 2-1

| | | End Face Having Low Porosity Portion ln represents inlet side of fluid, Out represents outlet side of fluid | End Face Having Low Porosity Portion ln represents inlet side of fluid Out represents outlet side of fluid | Extension Width of Low Porosity Portion | Extension Width of Low Porosity Portion/Total Length of Honeycomb Structure Portion | Porosity of Low Porosity Portion | Average Porosity of Whole | Porosity of Portion Other Than Low Porosity Portion |
|---|---|---|---|---|---|---|---|---|
| Unit | | - | - | mm | % | % | % | % |
| Example | 26 | Out | Out | 3 | 4.6 | 32.0 | 37.6 | 39.0 |
| Comparative Example | 2 | Non | - | - | - | - | 39.0 | - |

TABLE 2-2

| | (AP2-AP1/AP2)*100 (AP1): Average Porosity of Low Porosity Portion (AP2): Average Porosity of Portion Other Than Low Porosity Portion | Strength of Low Porosity Portion | Strength Ratio [Low Porosity Portion/Whole] | Average Strength of Whole | Young’s Modulus of Low Porosity Portion | Young’s Modulus Ratio [Low Porosity Portion/Whole] | Average Young’s Modulus of Whole | CTE | Thermal Shock Resistance Condition 2 |
|---|---|---|---|---|---|---|---|---|---|
| Unit | % | MPa | times | MPa | GPa | times | GPa | ppm/K | °C |
| Example | 18.0 | 45.7 | 1.2 | 40.3 | 67.0 | 1.1 | 60.6 | 4.30 | 900 |
| Comparative Example | - | - | - | 39.0 | - | - | 59.0 | 4.30 | 850 |

The specified temperature at which cracks were generated in Comparative Example 2 was 850° C., while the specified temperature at which cracks were generated in Example 26 was 900° C. It is understood that the results show the superiority of the honeycomb structure 20 having the low porosity portion 4.

### DESCRIPTION OF REFERENCE NUMERALS

10 honeycomb structure portion
12 outer peripheral wall
13 partition wall
14a, 14b electrode layer
15a, 15b electrode terminal
16 cell
20 honeycomb structure
30 electrically heating catalyst support
4 Low Porosity Portion

1. A honeycomb structure, comprising:
a ceramic honeycomb structure portion including: an outer peripheral wall; a partition wall arranged on an inner side of the outer peripheral wall, the partition wall defining a plurality of cells each extending from one end face to other end face to form a flow path; and
a pair of electrode layers each arranged so as to extend in a form of a band on an outer surface of the outer peripheral wall, across a central axis of the honeycomb structure portion,
wherein the honeycomb structure portion is provided in an end portion region(s) extending in a direction from the one end face and/or the other end face to a center in a flow path length direction of the honeycomb structure portion, and the honeycomb structure portion comprises at least one low porosity portion having a lower porosity than an average porosity of the whole honeycomb structure portion.

2. The honeycomb structure according to claim 1, wherein the one end face is an end face on a fluid inlet side.

3. The honeycomb structure according to claim 1, wherein the low porosity portion is provided in each end region extending from the one end face and the other end face to the center in the flow path length direction of the honeycomb structure portion.

4. The honeycomb structure according to claim 1, wherein an extension width of the low porosity portion in the flow path length direction of the honeycomb structure portion is 0.5% or more and 40% or less of the total length of the honeycomb structure portion in the flow path length direction of the honeycomb structure portion.

5. The honeycomb structure according to claim 1, wherein an extension width of the low porosity portion in the flow path length direction of the honeycomb structure portion is 0.3 mm or more and 20 mm or less.

6. The honeycomb structure according to claim 1, wherein a ratio of an average porosity (AP1) of the low porosity portion to an average porosity (AP2) of a portion other than the low porosity portion ({(AP2 — AP1) / AP2)} x 100) is 0.2% or more and 99.9% or less.

7. The honeycomb structure according to claim 1, wherein the partition wall of the low porosity portion contains a larger amount of oxide ceramics and/or silicon carbide than the partition wall of a portion other than the low porosity portion.

8. The honeycomb structure according to claim 1, wherein the low porosity portion has an average porosity of 0.1% or more and 40% or less.

9. The honeycomb structure according to claim 1, wherein the porosity of the low porosity portion gradually increases from the end face to the center in the flow path length direction of the honeycomb structure portion.

10. The honeycomb structure according to claim 1, wherein the low porosity portion has a strength higher than an average strength of the whole honeycomb structure portion.

11. The honeycomb structure according to claims 1, wherein the low porosity portion has a Young’s modulus higher than an average Young’s modulus of the whole honeycomb structure portion.

12. The honeycomb structure according to claim 1, wherein the low porosity portion has a thermal expansion coefficient equal to or higher than an average thermal expansion coefficient of the whole honeycomb structure.

13. The honeycomb structure according to claim 1, wherein the partition wall of the low porosity portion has a thickness higher than an average thickness of the partition wall of the whole honeycomb structure portion.

14. The honeycomb structure according to claim 1, wherein the low porosity portion has a volume resistivity lower than an average volume resistivity of the whole honeycomb structure.

15. An electrically heating catalyst support, comprising:
the honeycomb structure according to claim 1; and
a catalyst supported onto the honeycomb structure.

16. The electrically heating catalyst support according to claim 15, wherein the low porosity portion has a catalyst-supported thickness lower than an average catalyst-supported thickness of the whole honeycomb structure portion.

17. An exhaust gas purifying device, comprising:
the honeycomb structure according to claim 1;
electrode terminals provided on the pair of electrode layers; and
a metallic can body for holding the honeycomb structure.

18. The exhaust gas purifying device according to claim 17, wherein the one end face of the honeycomb structure is an end face on a fluid inlet side.
